(19) United States
(12) Patent Application Publication
(10) Pub. No.: US 2012/0118244 A1
(43) Pub. Date: May 17, 2012

(54) Grooming Table with Integrated Hair Collection System

(76) Inventor: Glenle W. FINCH, St Charles, MO (US)

(21) Appl. No.: 13/296,854

(22) Filed: Nov. 15, 2011

Related U.S. Application Data
(60) Provisional application No. 61/413,753, filed on Nov. 15, 2010.

(51) Int. Cl. A01K 13/00; B65F 1/14

(52) U.S. Cl. 119/600; 312/211

(57) ABSTRACT

A grooming table with an integrated hair and debris collection system. More specifically, the grooming table comprises a vent system that utilizes a blower to direct several streams of air current about a pet while being dried or groomed. The hair/debris that is released by the pet is carried by the air current into an air intake of the blower, where it is collected by a collection basket with filtration media. The air collected in the air current is recycled back into the blower without the hair and debris. The grooming table further comprises a blow dryer for concentrated air currents that can be manipulated by the user to dry a pet.

The current application claims a priority to the U.S. Provisional Patent application Ser. No. 61/413,753 filed on Nov. 15, 2010.

### FIELD OF THE INVENTION

The present invention relates generally to grooming table with a hair collection system. More specifically, as users are blow drying their pet dogs on the grooming table, the hair collection system keeps the hair from floating off

### BACKGROUND OF THE INVENTION

Currently, a major problem for dog washes is the issue of hair control. Once a user is finished washing their pet dogs, they want to air dry their dogs with a blow dryer. In other cases, users who are grooming their pet dogs and are required to blow dry to remove loose hairs. However, using a blow dryer often causes the pet dogs to release their hairs into the air. The airborne hair floats around in the space of the dog wash and can settle on the ground, making maintenance of cleanliness a difficult task. Airborne hair can also affect the comfort of all the customers using the dog washes. The present invention aims to overcome such a problem by introducing a grooming table with an integrated hair collection system for when users are blow drying their pet dogs. The integrated system allows free floating hairs to be carried away in the forced air current to be collected in a filter and a collection basket. The user is able to remove the basket to dispose of the collected hairs.

### BRIEF DESCRIPTION OF THE DRAWINGS

FIG. 1 is a perspective view of the present invention.

FIG. 2 is a perspective view of the present invention showing the grooming table top and the pair of side flaps being pivoted to an open position.

FIG. 3 is a perspective view of the present invention showing the air intake being pivoted into an open position revealing the intake opening and the collection basket.

FIG. 4 is a sectional view of the present invention without the collection basket showing the collection channel's connection to the internal air flow system. The blower is connected to the collection channel to intake air. The air manifold is connected to the blower to channel air into the vent frame.

### DETAIL DESCRIPTIONS OF THE INVENTION

All illustrations of the drawings are for the purpose of describing selected versions of the present invention and are not intended to limit the scope of the present invention.

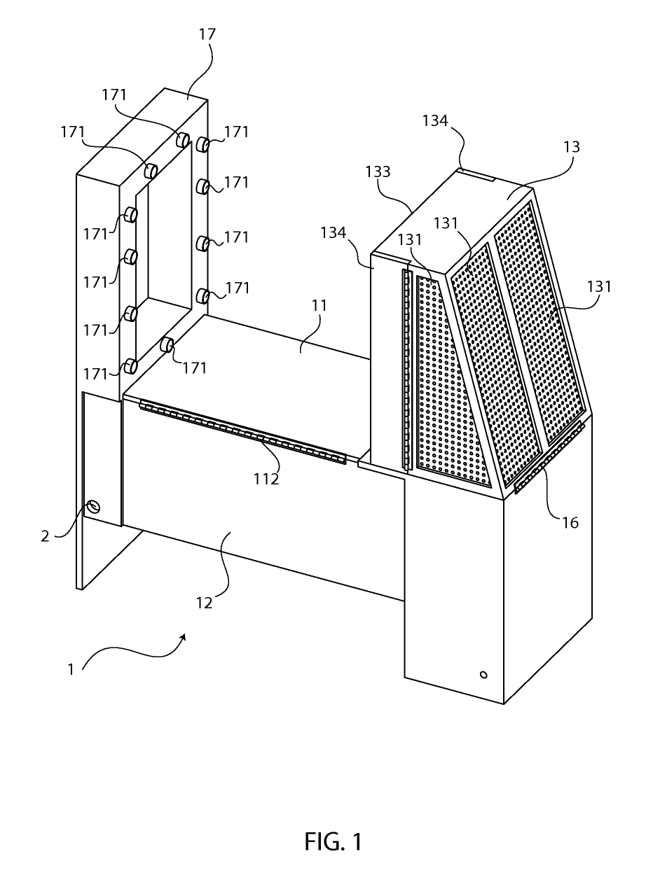

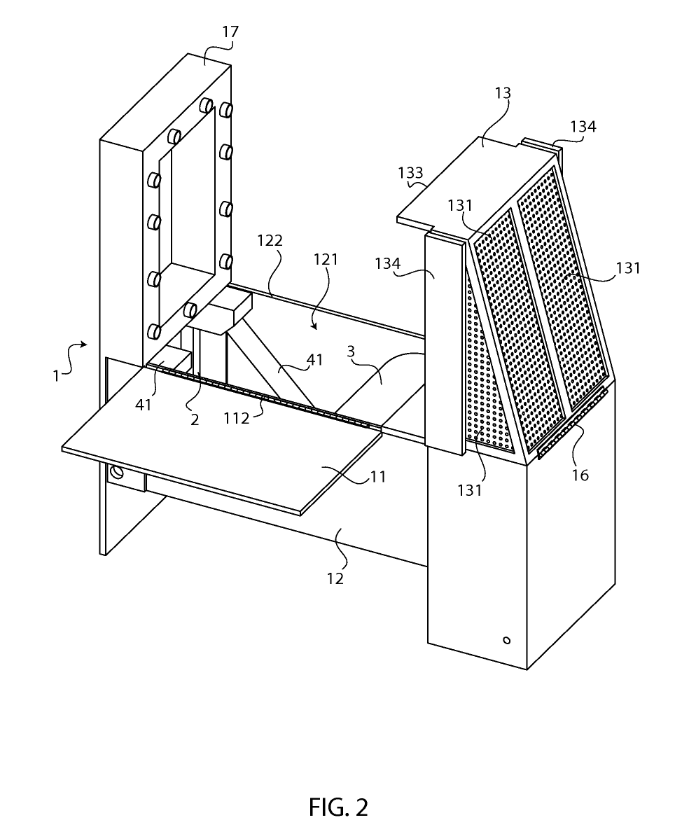

The present invention is a grooming table that provides an integrated air flow and collection system that is able to collect any hairs, nail clippings or other debris while grooming a pet. As a user is grooming a pet, hair and other debris fall off of the pet. The integrated air flow system is able to carry away the fallen/free floating hairs into the collection system. In reference to FIG. 1-4, the present invention comprises a table, a blow dryer 2, a blower 3, an air manifold 4, and a plurality of filtration media 5. The table 1 provides the user with an elevated surface for the user to groom and treat a pet. The blow dryer 2 provides the user with the ability to focus air onto the pet to properly dry the hair. The blower 3, being part of the integrated air flow system, provides the forced air currents to carry free floating hairs and debris into the collection system. The air manifold 4 is able to carry the forced air within the integrated air flow system to be forced out of designated vent hole.

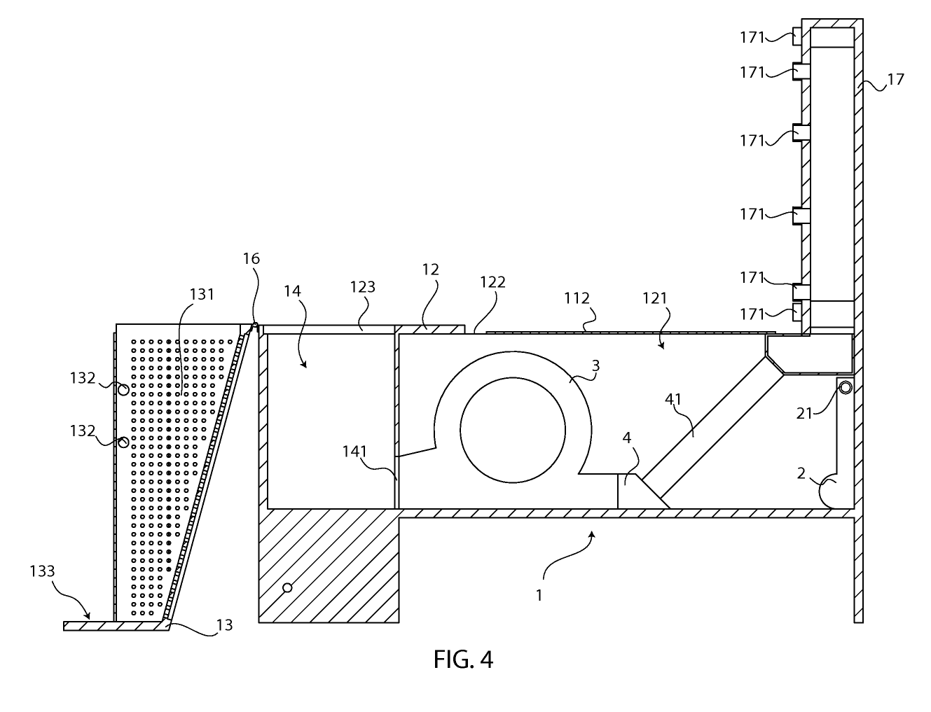

In reference to FIG. 1 and FIG. 4, the table 1 further comprises of a grooming table top 11, a compartment cabinet 12, an air intake 13, a collection channel 14, a collection basket 15, an air filter hinge 16, and a vent frame 17. The grooming table top 11 is surface of the table 1 in which the user is able to place their pets for grooming and other treatments. The vent frame 17 is connected to the compartment cabinet 12 in an upwards extending fashion. The vent frame 17 is a hollow frame that is used to channel forced air from the integrated air flow system. The hollow channel within the vent frame 17 is connected directly into the compartment cabinet 12. The vent hole further comprises of a plurality of vent holes 171. The plurality of vent holes 171 is holes traversing the vent frame 17 and is distributed on the vent frame 17 facing towards the air intake 13. The compartment cabinet 12 is a storage space that is aligned and positioned below the grooming table top 11. The compartment cabinet 12 further comprises a compartment space 121 and a top opening 122. The compartment space 121 is a recessed space in the compartment cabinet 12 that allows for the blower 3, the blow dryer 2 and the air manifold 4 to be stored and concealed. The hollow channel within the vent frame 17 is directly connected to the compartment space 121. The top opening 122 provides an opening into the compartment space 121 for the user to access the blower 3, the blow dryer 2, and the air manifold 4 in case there is a need for any maintenance. The grooming table top 11 is positioned over the top opening 122 and is jointly connected to the compartment cabinet 12 by a table hinge 112 to conceal the internal components of the present invention. With the blow dryer 2, the blower 3, and the air manifold 4 being positioned in the compartment space 121, the grooming table top 11 is able to conceal the integrated air flow system. Within the compartment space 121, the air manifold 4 is directly connected and sealed to the blower 3 to collect the forced air.

In reference to FIG. 4, the collection channel 14 is a channel that is positioned adjacent to the compartment cabinet 12. The collection channel 14 further comprises of an intake hole, a blower opening 141, and a dryer opening. The intake hole is a hole traversed through the top compartment cabinet 12. The intake hole and the collection channel 14 are sized and shaped to match the collection basket 15. The blower opening 141 is an opening that leads into the compartment space 121. The blower 3 is connected and sealed to the blower opening 141. The blower opening 141 provides the blower 3 with access to the outside space for air intake 13. Within the collection channel 14 is positioned the collection basket 15. The collection basket 15 comprises of a plurality of basket filter holes. The plurality of basket filter holes allows air to continue to flow through the collection channel 14 and into the blow dryer 2 and blower 3 through the dryer opening and the blower opening 141. The air intake 13 is positioned over the collection channel 14 and is used to collect hair particles into the collection basket 15 while funneling and pulling hair into the collection channel 14. The collection basket 15 can be used as a waste basket, making it easier for the user to dispose of unwanted materials like toe nails, ear cleaning pads, or hair/dander from pets during the grooming process. The air intake 13 of further comprises of a plurality of filter holes 131, a plurality of barrier bars 132, a frame opening 133, and a pair of side flaps 134. The air intake 13 is jointly connected to the table 1 by the air filter hinge 16. The joint connection of the air intake 13 to the table 1 allows the user to pivot the air filter from the table 1 to provide access to an intake opening 123. The intake opening 123 is traversed through the compartment cabinet leading into the collection channel 14. As a result, the user is also provided access to the collection basket 15 to dispose of collected wastes. The plurality of filter holes 131 is holes that are traversed through the air intake 13 and is evenly distributed about the air intake 13. The plurality of filter holes 131 allows air to continue to pass through the air intake 13 to prevent pressure buildup within the air intake 13. Without the plurality of filter holes 131, air pressure is able to build up within the air intake 13 and potentially cause an air vortex that can blow collected hairs and debris out of the collection basket 15. The plurality of barrier bars 132 is barriers that are connected across the frame opening 133. The plurality of barrier bars 132 is positioned on the frame opening 133 to prevent pets from falling into the collection basket 15. To provide better collection of hair and debris, the pair of side flaps 134 is jointly connected onto the frame opening 133 of the air intake 13. The side flaps extend the frame opening 133 towards the vent frame 17 to catch any loose flying hairs earlier and reduce the chances of hair escaping. The joint connections of the pair of side flaps 134 allow the user to fold the pair of side flaps 134 back towards the air intake 13 for more space to handle a pet.

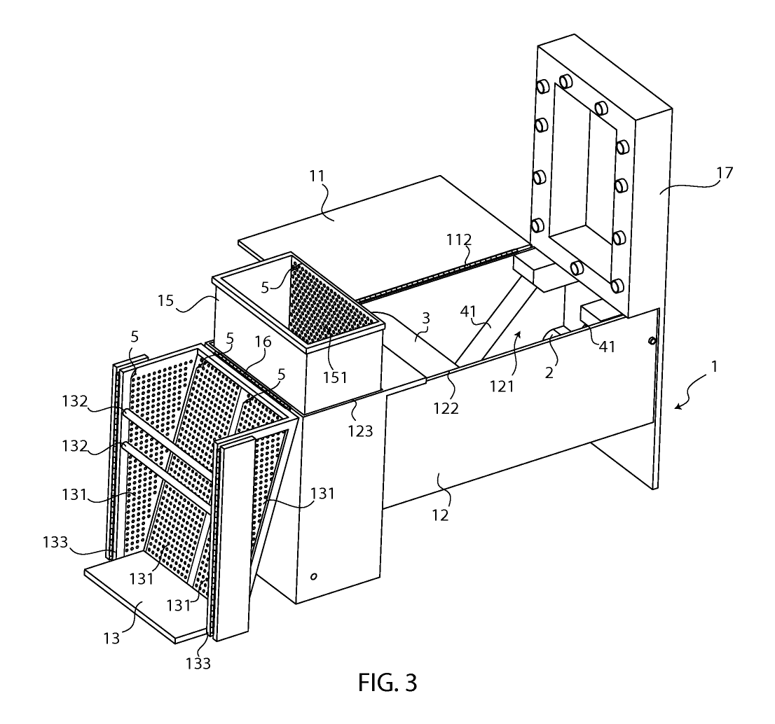

In reference to FIG. 3, the plurality of filtration media 5 is lined over the plurality of filter holes 131 of the internal surface of the air intake 13 and also attached over a plurality of basket holes 151 on the collection basket 15. The plurality of basket holes 151 is holes that is traversed through and distributed about the collection basket 15. With the collection basket 15 being positioned in the collection channel 14, the plurality of basket holes 151 allows continuous air flow through the collection channel 14. The plurality of filtration media 5 provides a barrier that is able to collect hair and debris while still allowing air flow through the plurality of filter holes 131 and the plurality of basket holes 151. As a result, the plurality of filter holes 131 is still able to allow air to pass through without causing a buildup of air pressure and the plurality of basket holes 151 are able to allow air to be collected by the blow dryer 2 and the blower 3. The plurality of filtration media 5 can be any type of standard filter media including pleated paper, wire mess, or even foam. Filters such as HEPA filters can be used to collect allergens along with the any hair. As forced air currents are blown into the air intake 13 and the collection channel 14, the filtration media 5 is able to collect hair. Once the filtration media 5 has collected a maximum amount of hair or debris, the user is able to remove and replace new filters onto the air intake 13 and the collection basket 15.

In reference to FIG. 4, the blow dryer 2 is operated independently from the blower 3. The blow dryer 2 is able to intake air through a dryer opening. The blow dryer 2 further comprises of a hose connection 21. The hose connection 21 is a tube that exhausts the forced air produced by the blow dryer 2. The hose connection 21 is traversed through and extends from the compartment cabinet 12. The user is able to connect a hose to the hose connection 21 to direct the forced air from the blow dryer 2 to a pet on top of the grooming table top 11. The blow dryer 2 of the present invention provides a means to quickly dry a pet that has just received a bath. The user is able to fasten a blow dryer 2 hose and nozzle to the hose connection 21 for manual manipulation over the pet.

Separate from the blow dryer 2, the blower 3 is able to intake air from the collection channel 14 from the blower opening 141. The blower 3 is then connected to the air manifold 4 within the compartment space 121. The air manifold 4 further comprises a plurality of air channels 41. The plurality of air channels 41 are connected directly to the vent frame 17. The air manifold 4 is able to direct the forced air from the blower 3 into the vent frame 17 by means of the plurality of air channels 41. The forced air traveling into the vent frame 17 is released by means of the plurality of vent holes 171. As a result, with the plurality of vent holes 171 directed towards the air intake 13, the air current is blown towards the air intake 13 to be funneled back into the collection channel 14. The air within the air intake 13 is pressurized and is funneled back into the collection channel 14. The air current is constantly being recycled while collecting any hair that is freely floating or resting on the grooming table top 11. When the user is using the blow dryer 2 to dry a pet, the air current from the plurality of vent holes 171 will travel over and around the pet to collect and loose hairs floating off in the air. The air current from the plurality of vent holes 171 will additionally prevent loose hairs from escaping or falling off the table 1. The plurality of vent holes 171 are distributed at varying heights to provide an even distribution of air current towards a pet on the grooming table top 11.

The vent frame 17 is additionally slightly elevated to allow vent holes to be positioned near the grooming table top 11. The low vent holes allow the air currents to be directed towards the feet of a pet while the higher vent holes are directed towards the pet's head and body. As the pet begins to dry, its hair is released into the cross-flow of air to be carried into the air intake 13 and the collection basket 15. The blow dryer 2 and the blower 3 are simultaneously operated and activated. This ensures that the plurality of vent holes 171 is releasing air currents to collect hair or debris while the user is either blow drying the pet or simply grooming the pet. The blower 3 and the blow dryer 2 are activated by means of a dryer switch and a blower 3 switch positioned on the side of the compartment cabinet 12. The dryer switch and the blower 3 switch are electronically connected to the blow dryer 2 and the blower 3, respectively.

The present invention is a system that is able to speed up a pet drying process while providing minimal discomfort to the pet and its handler. Additionally, with the hair and debris collection system, cleaning is simplified after the user has finished drying and grooming the pet. With much of the hair and debris being collected by the collection basket 15 and the plurality of filtration media 5, the user can simply remove the collection basket 15 and dump the collected hair/debris into a trash can.

In another embodiment of the present invention, the grooming table can additionally comprises of grooming restraints. The grooming restraints can be an extension from the vent frame 17 or be a bar connected from the vent frame 17 to the pass-through frame. The grooming restraints can be used to secure a pet from struggling and falling off of the grooming table top 11.

Although the invention has been explained in relation to its preferred embodiment, it is to be understood that many other possible modifications and variations can be made without departing from the spirit and scope of the invention as hereinafter claimed.

What is claimed is:

1. A grooming table with integrated hair collection system comprises,
a table;
a blow dryer;
a blower;
an air manifold;
a plurality of filtration media;
the table comprises a grooming table top, a compartment cabinet, an air intake, a collection channel, a collection basket, an air filter hinge, and a vent frame;
the blow dryer comprises a hose connection;
the compartment cabinet further comprises a compartment space, a top opening, and a compartment door;
the compartment space being a recessed space on the compartment cabinet;
the blow dryer being positioned in the compartment space;
the blower being positioned in the compartment space;
the air manifold being positioned in the compartment space; and
the air manifold being connected to the blower.

2. The grooming table with integrated hair collection system as claimed in claim 1 comprises,
the collection channel being positioned adjacent to the compartment cabinet opposite of the vent frame;
the collection channel comprises an intake hole and a blower opening;
the intake hole being traversed through the compartment cabinet;
the air intake further comprises a plurality of filter holes, a plurality of barrier bars, a frame opening, and a pair of side flaps;
the pair of side flaps being jointly connected to the frame opening;
the air intake being positioned over the collection channel; and
the air intake being jointly connected to the table by the air filter hinge.

3. The grooming table with integrated hair collection system as claimed in claim 2 comprises,
the plurality of filter holes being holes traversing through the air intake and being distributed about the air intake; and
the plurality of barrier bars being connected across the frame opening.

4. The grooming table with integrated hair collection system as claimed in claim 2 comprises,
the compartment cabinet comprises an intake opening;
the intake opening being a hole traversing the grooming table top leading into the collection channel;
the collection basket being positioned in the collection channel;
the plurality of filtration media being attached to the air intake over the plurality of filter holes and being attached over a plurality of basket holes of the collection basket; and
the plurality of basket holes being holes traversed through the collection basket.

5. The grooming table with integrated hair collection system as claimed in claim 1 comprises,
the top opening being positioned on a top side of the compartment cabinet leading into the compartment space;
the grooming table top being positioned over the top opening of the compartment cabinet; and
the grooming table top being jointly attached to the compartment cabinet by a table hinge.

6. The grooming table with integrated hair collection system as claimed in claim 1 comprises,
the vent frame being upwardly extended from the compartment cabinet;
the vent frame being hollow and connected to the compartment space;
the vent frame comprises a plurality of vent holes; and
the plurality of vent holes being distributed on the vent frame facing towards the air intake.

7. The grooming table with integrated hair collection system as claimed in claim 6 comprises,
the collection channel being connected to the blower by a blower opening;
the blower opening connecting the collection channel to the compartment space;
the blow dryer comprises a hose connection; and
the hose connection being traversed through and extending from the compartment cabinet.

8. The grooming table with integrated hair collection system as claimed in claim 6 comprises,
the blower being connected to the air manifold;
the air manifold comprises a plurality of air channels; and
the plurality of air channels being connected to the vent frame.

9. A grooming table with integrated hair collection system comprises,
a table;
a blow dryer;
a blower;
an air manifold;
a plurality of filtration media;
the table comprises a grooming table top, a compartment cabinet, an air intake, a collection channel, a collection basket, an air filter hinge, and a vent frame;
the blow dryer comprises a hose connection;
the compartment cabinet further comprises a compartment space, a top opening, and a compartment door;
the compartment space being a recessed space on the compartment cabinet;
the blow dryer being positioned in the compartment space;
the blower being positioned in the compartment space;
the air manifold being positioned in the compartment space;
the air manifold being connected to the blower;
the collection channel being positioned adjacent to the compartment cabinet opposite of the vent frame;
the collection channel comprises an intake hole and a blower opening;
the intake hole being traversed through the compartment cabinet;
the air intake further comprises a plurality of filter holes, a plurality of barrier bars, a frame opening, and a pair of side flaps;
the pair of side flaps being jointly connected to the frame opening;
the air intake being positioned over the collection channel; and
the air intake being jointly connected to the table by the air filter hinge.

10. The grooming table with integrated hair collection system as claimed in claim 9 comprises,
the plurality of filter holes being holes traversing through the air intake and being distributed about the air intake;
the plurality of barrier bars being connected across the frame opening;
the compartment cabinet comprises an intake opening;
the intake opening being a hole traversing the grooming table top leading into the collection channel;
the collection basket being positioned in the collection channel;
the plurality of filtration media being attached to the air intake over the plurality of filter holes and being attached over a plurality of basket holes of the collection basket; and
the plurality of basket holes being holes traversed through the collection basket.

11. The grooming table with integrated hair collection system as claimed in claim 9 comprises,
the top opening being positioned on a top side of the compartment cabinet leading into the compartment space;
the grooming table top being positioned over the top opening of the compartment cabinet; and
the grooming table top being jointly attached to the compartment cabinet by a table hinge.

12. The grooming table with integrated hair collection system as claimed in claim 9 comprises,
the vent frame being upwardly extended from the compartment cabinet;
the vent frame being hollow and connected to the compartment space;
the vent frame comprises a plurality of vent holes;
the plurality of vent holes being distributed on the vent frame facing towards the air intake;
the collection channel being connected to the blower by a blower opening;
the blower opening connecting the collection channel to the compartment space;
the blow dryer comprises a hose connection;
the hose connection being traversed through and extending from the compartment cabinet;
the blower being connected to the air manifold;
the air manifold comprises a plurality of air channels; and
the plurality of air channels being connected to the vent frame.

13. A grooming table with integrated hair collection system comprises,
a table;
a blow dryer;
a blower;
an air manifold;
a plurality of filtration media;
the table comprises a grooming table top, a compartment cabinet, an air intake, a collection channel, a collection basket, an air filter hinge, and a vent frame;
the blow dryer comprises a hose connection;
the compartment cabinet further comprises a compartment space, a top opening, and a compartment door;
the compartment space being a recessed space on the compartment cabinet;
the blow dryer being positioned in the compartment space;
the blower being positioned in the compartment space;
the air manifold being positioned in the compartment space;
the air manifold being connected to the blower;
the collection channel being positioned adjacent to the compartment cabinet opposite of the vent frame;
the collection channel comprises an intake hole and a blower opening;
the intake hole being traversed through the compartment cabinet;
the air intake further comprises a plurality of filter holes, a plurality of barrier bars, a frame opening, and a pair of side flaps;
the pair of side flaps being jointly connected to the frame opening;
the air intake being positioned over the collection channel;
the air intake being jointly connected to the table by the air filter hinge;
the vent frame being upwardly extended from the compartment cabinet;
the vent frame being hollow and connected to the compartment space;
the vent frame comprises a plurality of vent holes;
the plurality of vent holes being distributed on the vent frame facing towards the air intake;
the collection channel being connected to the blower by a blower opening;
the blower opening connecting the collection channel to the compartment space;
the plurality of filter holes being holes traversing through the air intake and being distributed about the air intake;
the plurality of barrier bars being connected across the frame opening;
the compartment cabinet comprises an intake opening;
the intake opening being a hole traversing the grooming table top leading into the collection channel;
the collection basket being positioned in the collection channel;
the plurality of filtration media being attached to the air intake over the plurality of filter holes and being attached over a plurality of basket holes of the collection basket; and
the plurality of basket holes being holes traversed through the collection basket.

14. The grooming table with integrated hair collection system as claimed in claim 9 comprises,
the top opening being positioned on a top side of the compartment cabinet leading into the compartment space;
the grooming table top being positioned over the top opening of the compartment cabinet; and
the grooming table top being jointly attached to the compartment cabinet by a table hinge.

15. The grooming table with integrated hair collection system as claimed in claim 9 comprises,
the blow dryer comprises a hose connection;
the hose connection being traversed through and extending from the compartment cabinet;
the blower being connected to the air manifold;
the air manifold comprises a plurality of air channels; and
the plurality of air channels being connected to the vent frame.
